(19) United States
(12) Patent Application Publication
(10) Pub. No.: US 2024/0013253 A1
(43) Pub. Date: Jan. 11, 2024

(54) POST-CAMPAIGN ANALYSIS SYSTEM

(71) Applicant: TURKCELL TEKNOLOJI ARASTIRMA VE GELISTIRME ANONIM SIRKETI, Istanbul (TR)

(72) Inventors: Emre BEYSUNGU, Istanbul (TR); Koray CETINGOZ, Istanbul (TR)

(73) Assignee: TURKCELL TEKNOLOJI ARASTIRMA VE GELISTIRME ANONIM SIRKETI, Istanbul (TR)

(21) Appl. No.: 18/025,384

(22) PCT Filed: Sep. 14, 2021
(86) PCT No.: PCT/TR2021/050926

§ 371 Date: Mar. 8, 2023

(30) Foreign Application Priority Data
Sep. 14, 2020 (TR) 2020/14503

(51) Int. Cl. G06Q 30/0242; G06Q 30/0204; G06Q 10/0637

(52) U.S. Cl. CPC G06Q 30/0245; G06Q 30/0204; G06Q 30/0246; G06Q 10/06375

(57) ABSTRACT

The present invention relates to a system (1) for carrying out estimation and analysis of revenue and subscriber expectations in relation to both a related campaign and campaigns to be conducted in the future when a campaign is over in telecommunication companies conducting mass campaigns and companies being engaged in other sectors.

### TECHNICAL FIELD

The present invention relates to a system for carrying out estimation and analysis of revenue and subscriber expectations in relation to both a related campaign and campaigns to be conducted in the future when a campaign is over in telecommunication companies conducting mass campaigns and companies being engaged in other sectors.

### BACKGROUND OF THE INVENTION

Today, companies being engaged in telecommunication and other sectors make various inferences such as measurement of revenue and customer satisfaction following campaigns they conduct. Companies are enabled to obtain important data such as revenue and added value they acquire from campaigns by means of such inferences that are usually made through manual methods. In addition, outcomes having a significant role for campaigns to be conducted in the future are obtained as well. However, carrying out such analysis manually sometimes causes audiences to be out of campaign and companies to conduct campaigns below their potentials.

Considering the studies included in the state of the art, it is understood that there is need for a system which enables companies to obtain outcomes about success of campaign and customer satisfaction related to a campaign following campaigns conducted by companies.

The United States patent document no. US2014365314, an application in the state of the art, discloses computer-implemented methods which use vendor/merchant sales data and customer purchasing data in order to best implement vendor offer campaigns by enabling to compute a set of campaigns for a given user in real time and also maximize the success. In this invention, multiple factors are statistically computed and combined to determine the best campaign for a user. In addition, the invention relates to a level of accomplishment of the active campaigns and their time remaining. Machine learning may be applied to assess a predicted level of interest of each user for the active campaigns. In other embodiments of the invention, the respective weights of various factors can be changed in order to adapt the algorithm to specific business goals. Audiences, i.e. retail customers that satisfy a set of filtering criteria, are defined in the invention. In the invention, financial behavior and monetary transaction data are used to target users. In addition, machine learning techniques are used in a model that predicts the likelihood of a user to purchase in a category.

### SUMMARY OF THE INVENTION

An objective of the present invention is to realize a system for obtaining data such as customer satisfaction, success of campaign related to a campaign upon an audience benefiting from a campaign is extracted as a result of campaigns conducted by companies.

Another objective of the present invention is to realize a system for ensuring that data such as customer satisfaction, success of campaign—which are obtained about campaigns conducted by companies—are used for improving future campaigns of companies.

### DETAILED DESCRIPTION OF THE INVENTION

“A Post-Campaign Analysis System” realized to fulfil the objectives of the present invention is shown in the figure attached, in which:

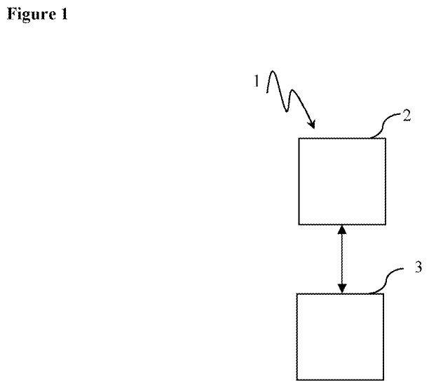

FIG. 1 is a schematic view of the inventive system.

The components illustrated in the figures are individually numbered, where the numbers refer to the following:

1. System

2. Data server

3. Analysis server

The inventive system (1) for carrying out estimation and analysis of revenue and subscriber expectations in relation to both a related campaign and campaigns to be conducted in the future when a campaign is over in telecommunication companies conducting mass campaigns and companies being engaged in other sectors comprises:
at least one data server (2) which is configured to group previous income, spending, behavior and demographic information about customers of a company and to store data suitable to be used in analysis thereof,
at least one analysis server (3) which is configured to create a control group by receiving customer data that are grouped in the data server (2) and made ready for analysis and to carry out an income & expense and impact analysis related to a campaign by comparing a campaign audience and behaviours of an audience before and after a campaign.

The data server (2) included in the inventive system (1) is configured to run on a timed basis, to obtain group customer information—in particular to previous income status, expenses, company behaviors and demographic information—of each company customer and then to group these by means of predetermined machine learning algorithms. The data server (2) is configured to group customers in terms of exhibiting same similar behavior as specific to metrics such as income they bring into the company, demographic characteristics and product/service usage habits. The data server (2) is configured to receive computational variables from various sources and create these variables so as to be used in the continuation of the flow. The data server (2) is configured to detect and then clear outliers that are incorrect in terms of data quality and/or that may lead to deviation in ongoing calculations, from calculated data and to merge data suitable for analysis. The data server (2) is configured to detect customers who are located closest to each other by using predetermined machine learning algorithms following the transaction of merging.

The analysis server (3) is configured to ensure that data that are made ready for analysis upon being extracted from the data server (2) and grouped and variables that will be used for campaign measurement, are received from required sources automatically on customer basis. The analysis server (3) is configured to control distribution of a campaign audience according to a grouping created by the data server (2). The analysis server (3) is configured to create a control group by taking samples over customers who will provide the same distribution and are included in a similar income group, on the basis of a customer who did not participate in a campaign, according to distribution ratio of a campaign audience within groups. The analysis server (3) is configured to compute income change of a campaign audience following a campaign participation, a customer's churn tendency for a campaign/company in a comparative way with a control group created. The analysis server (3) is configured to create a control group by taking samples over customers who will provide the same distribution and are included in a similar income group, on the basis of a customer who did not participate in a campaign, according to distribution ratio of a campaign audience within groups. The analysis server (3) is configured to compute income change of a campaign audience following a campaign participation, a customer's churn tendency for a campaign/company in a comparative way with a control group created. The analysis server (3) is configured to simulate a control group according to layers (such as income, consumption, product ownership) determined by users of a campaign audience. The analysis server (3) is configured to create total income-expense tables of a campaign and to submit the obtained results to an authorized user. In a preferred embodiment of the invention, the analysis server (3) is configured such that it can be used by different users at the same time.

In the inventive system (l), demographic information and company-customer information about company customers are received and then grouped by means of predetermined algorithms. Data, which are grouped upon being made ready for analysis, are received by the analysis server (3) and then analysed in a comparative way on subjects such as income change, churn tendency of customers who have participated the campaign, with a control group created on the basis of customers who did not participate the campaign. Thus, effects of a campaign is analysed automatically and comparatively and these can be used for improving future campaigns.

Within these basic concepts; it is possible to develop various embodiments of the inventive system (1); the invention cannot be limited to examples disclosed herein and it is essentially according to claims.

1. A system (1) for carrying out estimation and analysis of revenue and subscriber expectations in relation to both a related campaign and campaigns to be conducted in the future when a campaign is over in telecommunication companies conducting mass campaigns and companies being engaged in other sectors comprising:
at least one data server (2) which is configured to group previous income, spending, behavior and demographic information about customers of a company and to store data suitable to be used in analysis thereof; and characterized by
at least one analysis server (3) which is configured to create a control group by receiving customer data that are grouped in the data server (2) and made ready for analysis and to carry out an income & expense and impact analysis related to a campaign by comparing a campaign audience and behaviours of an audience before and after a campaign.

2. A system (1) according to claim 1; characterized by the data server (2) which is configured to run on a timed basis, to obtain group customer information—in particular to previous income status, expenses, company behaviors and demographic information—of each company customer and then to group these by means of predetermined machine learning algorithms.

3. A system (1) according to claim 1; characterized by the data server (2) which is configured to group customers in terms of exhibiting same similar behavior as specific to metrics such as income they bring into the company, demographic characteristics and product/service usage habits.

4. A system (1) according to claim 1, characterized by the data server (2) which is configured to receive computational variables from various sources and to create these variables so as to be used in the continuation of the flow.

5. A system (1) according to claim 1, characterized by the data server (2) which is configured to detect and then clear outliers that are incorrect in terms of data quality and/or that may lead to deviation in ongoing calculations, from calculated data and to merge data suitable for analysis.

6. A system (1) according to claim 1, characterized by the data server (2) which is configured to detect customers who are located closest to each other by using predetermined machine learning algorithms following the transaction of merging.

7. A system (1) according to claim 1, characterized by the analysis server (3) which is configured to ensure that data that are made ready for analysis upon being extracted from the data server (2) and grouped and variables that will be used for campaign measurement, are received from required sources automatically on customer basis.

8. A system (1) according to claim 1, characterized by the analysis server (3) which is configured to control distribution of a campaign audience according to a grouping created by the data server (2).

9. A system (1) according to claim 1, characterized by the analysis server (3) which is configured to create a control group by taking samples over customers who will provide the same distribution and are included in a similar income group, on the basis of a customer who did not participate in a campaign, according to distribution ratio of a campaign audience within groups.

10. A system (1) according to claim 1, characterized by the analysis server (3) which is configured to compute income change of a campaign audience following a campaign participation, a customer's churn tendency for a campaign/company in a comparative way with a control group created.

11. A system (1) according to claim 1, characterized by the analysis server (3) which is configured to simulate a control group according to layers determined by users of a campaign audience.

12. A system (1) according to claim 1, characterized by the analysis server (3) which is configured to create total income-expense tables of a campaign and to submit the obtained results to an authorized user.

13. A system (1) according to claim 1, characterized by the analysis server (3) which is configured such that it can be used by different users at the same time.
